(19) United States
(12) Patent Application Publication
(10) Pub. No.: US 2014/0281271 A1
(43) Pub. Date: Sep. 18, 2014

(54) CACHE CONTROL DEVICE, PROCESSOR, INFORMATION PROCESSING SYSTEM, AND CACHE CONTROL METHOD

(71) Applicant: Sony Corporation, Tokyo (JP)

(72) Inventors: Tsuyoshi Miura, Tokyo (JP); Hiroshi Yoshikawa, Kanagawa (JP)

(73) Assignee: Sony Corporation, Tokyo (JP)

(21) Appl. No.: 14/197,239

(22) Filed: Mar. 5, 2014

(30) Foreign Application Priority Data
Mar. 14, 2013 (JP) 2013-051324

(51) Int. Cl. G06F 12/08

(52) U.S. Cl. CPC G06F 12/0815
USPC 711/143

(57) ABSTRACT

A cache control device includes: a tag storage section configured to manage, for each cache line of a cache memory, whether or not the cache line is valid, and whether or not a write-back instruction to a shared storage section is provided; and a tag control section configured not to invalidate a cache line for which the write-back instruction is already provided, and to invalidate a cache line for which the write-back instruction is not provided, when a predetermined instruction is provided.

### CROSS REFERENCE TO RELATED APPLICATIONS

This application claims the benefit of Japanese Priority Patent Application JP2013-51324 filed Mar. 14, 2013, the entire contents of which are incorporated herein by reference.

### BACKGROUND

The present technology relates to a cache control device. Specifically, the present technology relates to a cache control device of a local cache memory holding data of a shared storage section. The present technology also relates to a processor as well as an information processing system each including the cache control device, and a cache control method.

In a system having a configuration in which a plurality of processors each including a local cache access a shared memory common thereto, it is necessary to keep consistency of data in the entire system, while sharing data among the processors. Therefore, it is necessary for each of the processors to appropriately perform write-back processing and invalidation processing for data on its own local cache. In other words, for the processor updating the shared data, it is necessary to write information after the update, back to the shared memory. On the other hand, for the processor referring to the shared data, it is necessary to invalidate pre-update data remaining on its own local cache, in order to refer to post-update data present on the shared memory. At that time, if all cache lines are invalidated, and all cache lines are written back to the shared memory after completion of processing, the local cache is not allowed to be used effectively between threads, and besides, useless processing of writing back unnecessary cache lines occurs.

In contrast, there has been proposed a system in which a flag indicating whether or not data is shared data is held in each cache line in a local cache, and only a line in which the flag is set is invalidated (for example, see Japanese Unexamined Patent Application Publication No. H02-100741). Further, there has been proposed a system in which a range of addresses to be invalidated is set beforehand, and only a cache line holding data included in this range is invalidated (for example, see Japanese Unexamined Patent Application Publication No. 2009-282920).

### SUMMARY

In the above-described existing techniques, the cache lines to be invalidated are limited, and therefore the local caches may be effectively utilized. However, in the case of utilizing the flag indicating the shared data, primarily necessary shared data may be invalidated, when thread scheduling is dynamically performed in multi-thread programming. Further, in the case of setting the range of addresses to be invalidated, there is such a disadvantage that the addresses to be invalidated are desired to be sequential, which is not flexible.

It is desirable to keep consistency of data in a cache memory efficiently, in a dynamic thread scheduling environment.

According to an embodiment of the present technology, there is provided a cache control device including: a tag storage section configured to manage, for each cache line of a cache memory, whether or not the cache line is valid, and whether or not a write-back instruction to a shared storage section is provided; and a tag control section configured not to invalidate a cache line for which the write-back instruction is already provided, and to invalidate a cache line for which the write-back instruction is not provided, when a predetermined instruction is provided. This provides a function of performing control not to invalidate primarily necessary shared data.

Advantageously, the tag control section may be configured to cause, when the write-back instruction is provided, the tag storage section to store content indicating that the write-back is instructed, and the tag control section may be configured to cause, when the predetermined instruction is provided, the tag storage section to store content indicating that the write-back instruction is not provided, for the cache line for which the write-back instruction is already provided. With this, presence or absence of the write-back instruction is managed in the tag storage section.

Advantageously, the predetermined instruction may be an instruction intended to invalidate the cache line for which the write-back instruction is not provided. With this, control not to invalidate primarily necessary shared data is performed in invalidation.

Advantageously, the predetermined instruction may be provided before processing of a thread is newly executed and the write-back instruction may be provided after processing of a thread is performed.

Advantageously, the tag storage section may be configured to store, for each cache line, a validity flag indicating whether the cache line is valid or invalid, and a write-back flag indicating whether write-back of data corresponding to the cache line to the shared storage section is instructed or not.

According to an embodiment of the present technology, there is provided a processor including: an instruction processing section; a tag storage section configured to manage, for each cache line of a cache memory, whether or not the cache line is valid, and whether or not a write-back instruction to a shared storage section is provided; and a tag control section configured not to invalidate a cache line for which the write-back instruction is already provided, and to invalidate a cache line for which the write-back instruction is not provided, when a predetermined instruction is provided from the instruction processing section. This provides a function of performing control not to invalidate primarily necessary shared data, when the predetermined instruction is provided from the instruction processing section.

According to an embodiment of the present technology, there is provided an information processing system including: a shared storage section; an instruction processing section; a tag storage section configured to manage, for each cache line of a cache memory, whether or not the cache line is valid, and whether or not a write-back instruction to a shared storage section is provided; and a tag control section configured not to invalidate a cache line for which the write-back instruction is already provided, and to invalidate a cache line for which the write-back instruction is not provided, when a predetermined instruction is provided from the instruction processing section. This provides a function of performing control not to invalidate shared data for which the write-back instruction to the shared storage section is provided, when the predetermined instruction is provided from the instruction processing section.

According to an embodiment of the present technology, there is provided a cache control method including: receiving an invalidate instruction intended to invalidate a cache line for which write-back instruction from a cache memory to a shared storage section is not provided; and avoiding invalidating a cache line for which the write-back instruction is already provided, and invalidating a cache line for which the write-back instruction is not provided, when receiving the invalidate instruction. This provides a function of performing control not to invalidate primarily necessary shared data.

According to the above-described embodiments of the present technology, consistency of data in the cache memory is allowed to be efficiently maintained in a dynamic thread scheduling environment.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to describe the principles of the technology.

FIG. 1 is a diagram illustrating an overall configuration example of an information processing system in an embodiment of the present technology.

FIG. 2 is a diagram illustrating a configuration example of a local cache 120 in the embodiment of the present technology.

FIG. 3 is a diagram illustrating a configuration example of a tag storage section 130 in the embodiment of the present technology.

FIG. 4 is a diagram illustrating a functional configuration example of a tag control section 140 in the embodiment of the present technology.

FIG. 5 is a diagram illustrating a transition example of the tag storage section 130, at the time when a write-back instruction is provided from an instruction processing section 110, in the embodiment of the present technology.

FIG. 6 is a flowchart presenting a processing procedure example, at the time when a conditional invalidate instruction is provided from the instruction processing section 110, in the embodiment of the present technology.

FIG. 7 is a diagram illustrating a transition example of the tag storage section 130, at the time when the conditional invalidate instruction is provided from the instruction processing section 110, in the embodiment of the present technology

FIG. 8 is a flowchart presenting a processing procedure example of thread processing in the embodiment the present technology.

FIG. 9 is a diagram illustrating an example of a relationship between threads in multi-thread programming.

FIG. 10 is a diagram illustrating transitions of cache lines in the multi-thread programming example of FIG. 9.

### DETAILED DESCRIPTION

An embodiment of the present technology will be described below with reference to the drawings. The description will be provided in the following order.

1. Embodiment (tag control of a local cache memory)
2. Application example (an application example to multi-thread programming)

### 1. Embodiment

### Configuration of Information Processing System

FIG. 1 is a diagram illustrating an overall configuration example of an information processing system in an embodiment of the present technology. In this information processing system, a plurality of processors 100 are connected to a shared memory 200. Each of the processors 100 includes an instruction processing section 110 and a local cache 120.

The instruction processing section 110 executes various instructions included in a program. Data necessary for the execution of the instructions is stored in the shared memory 200. The instruction processing section 110 reads data from the shared memory 200, in response to a read instruction (a load instruction). At this moment, when a cache line including target data is held in the local cache 120, a read time is reduced by obtaining the data from the local cache 120.

The local cache 120 is a cache memory provided to hold data stored in the shared memory 200. In the information processing system in this embodiment, the local cache 120 is provided for each of the processors 100, and therefore it is necessary to proceed with processing while maintaining mutual consistency. Control therefor will be described in detail later.

The shared memory 200 is a memory shared by the plurality of processors 100. Here, description will be provided assuming that a two-level hierarchy including the shared memory and the local cache is provided as a storage hierarchy. However, the hierarchy may be modified in various ways, such as, further providing a shared cache and using the local cache as a secondary cache. It is to be noted that the shared memory 200 is a specific but not limitative example of “shared storage section” in one embodiment of the present technology.

### [Configuration of Local Cache]

FIG. 2 is a diagram illustrating a configuration example of the local cache 120 in the embodiment of the present technology. Each of the local caches 120 includes a tag storage section 130, a tag control section 140, a data storage section 150, and a data control section 160. The instruction processing section 110 is connected to the tag control section 140 by a signal line 118, and to the data control section 160 by a signal line 119. Further, the shared memory 200 is connected to the tag control section 140 by a signal line 128, and to the data control section 160 by a signal line 129.

The data storage section 150 is a memory provided to store data corresponding to a part of the shared memory 200, for each cache line. The tag storage section 130 is a memory provided to store a tag address corresponding to each cache line and management information necessary for management of the cache line. In the following, the description will be provided assuming that a direct mapping method is adopted, although a set associative method may be adopted.

The tag control section 140 is provided to refer to and update the tag address and the management information stored in the tag storage section 130, according to an instruction from the instruction processing section 110. The data control section 160 is provided to manage the cache lines stored in the data storage section 150.

When a read instruction is issued from the instruction processing section 110, the tag control section 140 determines whether or not applicable data is held in the data storage section 150, based on the tag address and the management information. When the data is stored in the data storage section 150, the tag control section 140 notifies the data control section 160 of a cache hit. On the other hand, when the data is not stored in the data storage section 150, the tag control section 140 notifies the data control section 160 of a cache miss.

When being notified of the cache hit from the tag control section 140, the data control section 160 reads an applicable cache line from the data storage section 150 and returns the read cache line to the instruction processing section 110. On the other hand, when being notified of the cache miss from the tag control section 140, the data control section 160 reads an applicable cache line from the shared memory 200, returns the read cache line to the instruction processing section 110, and allocates the read cache line as a new cache line.

When a write instruction is issued from the instruction processing section 110, the tag control section 140 determines whether or not applicable data is held in the data storage section 150, based on the tag address and the management information. When the data is held in the data storage section 150, the tag control section 140 updates the cache line and records this event in the management information. In this embodiment, the description is provided assuming use of a method in which an updated cache line is not immediately written back to the shared memory (a copy-back method). However, a method in which an updated cache line is immediately written back (a write-through method) may be adopted. It is to be noted that in a case in which applicable data is not held in the data storage section 150 when the write instruction is issued, the tag control section 140 causes the data storage section 150 to store write data by securing a new cache line.

In addition to requesting reading and writing of data, the instruction processing section 110 issues an explicit cache operating instruction used to change the state of the cache, to the local cache 120. A write-back instruction of causing write-back of data on a cache to a memory, an invalidate instruction of invalidating data on a cache, and the like are known in general as this explicit cache operating instruction. In this embodiment, a conditional invalidate instruction of invalidating a cache line for which the write-back instruction is not provided is newly introduced as the explicit cache operating instruction.

FIG. 3 is a diagram illustrating a configuration example of the tag storage section 130 in the embodiment of the present technology. The tag storage section 130 stores the tag address corresponding to each cache line of the data storage section 150 and the management information necessary for the management of the cache line. Specifically, a valid flag (V) 131, a dirty flag (D) 132, and a write-back (WB) flag 133 are stored as the management information. Further, the tag address is stored in a tag 134.

The valid flag 131 is a flag indicating validity of a corresponding cache line. In the following, for example, the valid flag 131 is assumed to indicate “1” when the cache line is valid, and to indicate “0” when the cache line is invalid. When the cache line is invalidated, the valid flag 131 is reset to “0”. It is to be noted that the valid flag 131 is a specific but not limitative example of “validity flag” in one embodiment of the present technology.

The dirty flag 132 is a flag indicating whether or not the corresponding cache line agrees with the contents of the shared memory 200. In the following, for example, the dirty flag 132 is assumed to indicate “0” when there is agreement, and to indicate “1” when there is disagreement. When the data held in the local cache 120 is corrected (updated), the dirty flag 132 indicates “1”, until the data is written back to the shared memory 200.

The write-back flag 133 is a flag indicating whether or not the write-back instruction to the shared memory 200 is provided for the corresponding cache line. In the following, for example, the write-back flag 133 is assumed to indicate “1” when the write-back instruction is provided, and to indicate “0” when the write-back instruction is not provided. In this case, when the write-back instruction is provided by the instruction processing section 110, the write-back flag 133 is asserted to be “1”. Subsequently, when the conditional invalidation instruction is provided by the instruction processing section 110, the write-back flag 133 is reset to “0”. Further, when data is newly allocated on the cache as a result of occurrence of a cache miss, the write-back flag 133 of an applicable cache line enters a reset state.

The tag 134 stores a part of an address in the shared memory 200, of the corresponding cache line, as the tag address.

### [Operation of Local Cache]

FIG. 4 is a diagram illustrating a functional configuration example of the tag control section 140 in the embodiment of the present technology. Here, a write-back processing section 141 and an invalidation processing section 142 are each provided as a function of the tag control section 140.

The write-back processing section 141 is provided to perform processing when the write-back instruction is provided by the instruction processing section 110. The write-back of data to the shared memory 200 is performed through the data control section 160. In this process, the write-back processing section 141 asserts the write-back flag 133.

The invalidation processing section 142 is provided to perform processing when the conditional invalidation instruction is provided by the instruction processing section 110. When the conditional invalidation instruction is provided, the invalidation processing section 142 does not perform the invalidation when the write-back flag 133 indicates “1”, and performs the invalidation only when the write-back flag 133 indicates “0”. When the write-back instruction is provided, an aim of transferring the data to other processor is presumed, and the invalidation is controlled utilizing this. Hence, the invalidation processing section 142 resets the valid flag 131 to “0” when the write-back flag 133 indicates “0”, and when the write-back flag 133 indicates “1”, the invalidation processing section 142 resets the write-back flag 133 to “0” without changing the valid flag 131.

FIG. 5 is a diagram illustrating a transition example of the tag storage section 130, when the write-back instruction is provided by the instruction processing section 110, in the embodiment of the present technology. In FIG. 5, “*” indicates that the flag may be either “0” or “1”.

When the write-back is performed for the cache line for which the valid flag 131 indicates “1”, the write-back flag 133 is asserted to be “1”. Further, due to the write-back, the cache line agrees with the contents of the shared memory 200, and therefore the dirty flag 132 is reset to “0”.

FIG. 6 is a flowchart presenting a processing procedure example at the time when the conditional invalidate instruction is provided by the instruction processing section 110, in the embodiment of the present technology.

First, upon receipt of the conditional invalidate instruction from the instruction processing section 110 (step S911: Yes), the valid flag 131 is checked (step S912). When the valid flag 131 indicates “0” (step S912: Yes), the processing ends without performing anything (step S913). At this moment, the valid flag 131 indicates “0”, and the write-back flag 133 is either “0” or “1”.

When the valid flag 131 indicates “1” (step S912: No), the write-back flag 133 is checked (step S914). When the write-back flag 133 indicates “0” (step S914: Yes), the valid flag 131 is reset to “0”, and the cache line is thereby invalidated (step S915). When the write-back flag 133 indicates “1” (step S914: No), the valid flag 131 is maintained at “1”, and the write-back flag 133 is reset to “0” (step S916).

FIG. 7 is a diagram illustrating a transition example of the tag storage section 130 at the time when the conditional invalidation instruction is provided by the instruction processing section 110, in the embodiment of the present technology. In FIG. 7, “*” indicates that the flag may be either “0” or “1”.

Upon instruction of the conditional invalidation for the cache line in which the valid flag 131 indicates “1”, the invalidation is performed when the write-back flag 133 indicates “0”, but the invalidation is not performed when the write-back flag 133 indicates “1”. Further, there is no change in the dirty flag 132, even if the invalidation is not performed.

### 2. Application Example

An example in which the embodiment of the present technology is applied to multi-thread programming will be described below.

### [Processing in Thread]

FIG. 8 is a flowchart presenting a processing procedure example of thread processing in the embodiment the present technology. A main part of the thread processing is data reference and update (step S902). However, invalidation of a cache line is performed as preprocessing (step S901). As the invalidation in this stage, the invalidation processing based on the above-described conditional invalidate instruction is performed. Further, following completion of the data reference and update, the write-back of the cache line is performed as postprocessing (step S903).

When the write-back instruction is provided at the end of the thread processing (step S903), such an aim that it is necessary to transfer the data for other new thread processing is presumed, and therefore, the data is positively used in the new thread. Hence, when the write-back flag 133 is “1”, the cache line is utilized without being invalidated (step S901). This makes it possible to perform control not to invalidate primarily necessary shared data.

### Specific Example

FIG. 9 is a diagram illustrating an example of a relationship between threads in the multi-thread programming. Here, four threads A, B, C, and D are assumed to be used. Data X and data Y are newly defined in the thread A. The data X is referred to and updated to data X′ in the thread B. The data Y is referred to and updated to data Y′ in the thread C. Further, the data X′ and the data Y′ are referred to in the thread D.

Assignment of the threads and the processors is as follows. The thread A and the thread B may be performed in either a processor #i or a processor #j. The thread C is performed in the processor where the thread B is not performed. The thread D is performed in the processor where either the thread B or the thread C is executed, whichever is later in terms of completion of execution. In this example, the threads A, B, and D are assumed to be performed in the processor #i, and the thread C is assumed to be performed in the processor #j.

Processing in the thread A is performed in the following procedure.

A-1: For all cache entries, the conditional invalidation of the cache line in consideration of the write-back flag 133 is performed. Here, all the cache lines are invalidated.

A-2: The data X and the data Y are defined and referred to. The cache line including each of the data X and the data Y may be dirty.

A-3: The cache line including each of the data X and the data Y is written back to the shared memory 200. There is no possibility that the cache line including each of the data X and the data Y is dirty. When the cache line including each of the data X and the data Y is valid, the write-back flag 133 is asserted to be “1”.

Processing in the thread B is performed in the following procedure.

B-1: For all cache entries, the conditional invalidation of the cache line in consideration of the write-back flag 133 is performed. When the cache line including each of the data X and the data Y is valid, the write-back flag 133 is reset to “0” without invalidation. On the other hand, the remaining cache lines are invalidated because the write-back flag 133 is “0”.

B-2: The data X defined in the thread A is referred to, and then updated to the data X′. The cache line including the data X′ may be dirty.

B-3: The cache line including the data X′ is written back to the shared memory 200. There is no possibility that the cache line including the data X′ is dirty. When the cache line including the data X′ is valid, the write-back flag 133 is asserted to be “1”.

Processing in the thread C is performed in the following procedure.

C-1: For all cache entries, the conditional invalidation of the cache line in consideration of the write-back flag 133 is performed. All the cache lines are invalidated.

C-2: The data Y defined in the thread A is referred to, and then updated to the data Y′. The cache line including the data Y′ may be dirty.

C-3: The cache line including the data Y′ is written back to the shared memory 200. There is no possibility that the cache line including the data Y′ is dirty. When the cache line including the data Y′ is valid, the write-back flag 133 is asserted to be “1”.

Processing in the thread D is performed in the following procedure.

D-1: For all cache entries, the conditional invalidation of the cache line in consideration of the write-back flag 133 is performed. When the cache line including the data X′ is valid, the write-back flag 133 is reset to “0”. On the other hand, the remaining cache lines are invalidated because the write-back flag 133 is “0”.

D-2: The data X′ and the data Y′ defined in the thread B and the thread C are referred to. There is no possibility that the cache line including each of the data X′ and the data Y′ is dirty.

D-3: The cache line including each of the data X′ and the data Y′ is written back to the shared memory. There is no possibility that the cache line including each of the data X′ and the data Y′ is dirty. When the cache line including each of the data X′ and the data Y′ is valid, the write-back flag 133 is asserted to be “1”.

Here, in the D-2, as for the data X′, valid data may exist on the local cache 120, and therefore, it may be expected to improve processing performance of the system, by utilizing the data on the local cache 120. In addition, as for the data Y′, it may be certain that the data Y before the update is absent on the cache, and therefore it is possible to access right data by performing reading from the shared memory 200, reliably.

In this way, for the data which is not the shared data, invalidation is performed at the beginning of each thread processing, and therefore it is possible to suppress unnecessary write-back.

FIG. 10 is a diagram illustrating transitions of cache lines in the example of the multi-thread programming of FIG. 9.

In “a” in FIG. 10, the cache lines of the processor #i are all in an invalidated state at the beginning of the thread A. What is indicated in “b” in FIG. 10 is a state in which the data X, the data Y, and data Z are defined in the processing of the thread A. What is indicated in “c” in FIG. 10 is a state in which the write-back instruction is provided for the data X and the data Y, at the end of the thread A.

What is indicated in “d” in FIG. 10 is that, in the cache lines of the processor #i, the data Z is invalidated, whereas the data X and the data Y are not invalidated, at the beginning of the thread B. What is indicated in “e” in FIG. 10 is a state in which the data X is updated to the data X′ in the processing of the thread B. What is indicated in “f” in FIG. 10 is a state in which the write-back instruction is provided for the data X′ at the end of the thread B.

In “g” in FIG. 10, the cache lines of the processor #j are all in an invalidated state at the beginning of the thread C. What is indicated in “h” in FIG. 10 is a state in which the data Y is referred to in the processing of the thread C. What is indicated in “i” in FIG. 10 is a state in which the data Y is updated to the data Y′ in the processing of the thread C. What is indicated in “j” in FIG. 10 is a state in which the write-back instruction is provided for the data Y′ at the end of the thread C.

What is indicated in “k” in FIG. 10 is that, in the cache lines of the processor #i, the data Y is invalidated, whereas the data X′ is not invalidated, at the beginning of the thread D. What is indicated in “1” in FIG. 10 is a state in which the data Y′ is referred to in the processing of the thread D. This data Y′ is data written back to the shared memory 200 from the processor #j, and then allocated to the processor #i. What is indicated in “m” in FIG. 10 is a state in which the write-back instruction is provided for the data X′ and the data Y′ at the end of the thread D.

In this way, according to the embodiment of the present technology, in maintaining consistency of data in the cache memory in a dynamic thread scheduling environment, it is possible to perform control not to invalidate primarily necessary shared data.

It is to be noted that the above-described embodiment is an example used to realize the present technology, and the elements in the above-described embodiment correspond to elements in one embodiment of the present technology. Similarly, elements in one embodiment of the present technology correspond to the elements provided with the same designations as those thereof in the above-described embodiment. However, the present technology is not limited to the above-described embodiment, and may be realized by variously modifying the above-described embodiment in the scope not deviating from the gist thereof.

It is possible to achieve at least the following configurations from the above-described example embodiments of the disclosure.

(1) A cache control device including:

a tag storage section configured to manage, for each cache line of a cache memory, whether or not the cache line is valid, and whether or not a write-back instruction to a shared storage section is provided; and

a tag control section configured not to invalidate a cache line for which the write-back instruction is already provided, and to invalidate a cache line for which the write-back instruction is not provided, when a predetermined instruction is provided.

(2) The cache control device according to (1), wherein the tag control section is configured to cause, when the write-back instruction is provided, the tag storage section to store content indicating that the write-back is instructed, and the tag control section is configured to cause, when the predetermined instruction is provided, the tag storage section to store content indicating that the write-back instruction is not provided, for the cache line for which the write-back instruction is already provided.
(3) The cache control device according to (1) or (2), wherein the predetermined instruction is an instruction intended to invalidate the cache line for which the write-back instruction is not provided.
(4) The cache control device according to any one of (1) to (3), wherein the predetermined instruction is provided before processing of a thread is newly executed.
(5) The cache control device according to any one of (1) to (4), wherein the write-back instruction is provided after processing of a thread is performed.
(6) The cache control device according to any one of (1) to (5), wherein the tag storage section is configured to store, for each cache line,

a validity flag indicating whether the cache line is valid or invalid, and

a write-back flag indicating whether write-back of data corresponding to the cache line to the shared storage section is instructed or not.

(7) A processor including:

an instruction processing section;

a tag storage section configured to manage, for each cache line of a cache memory, whether or not the cache line is valid, and whether or not a write-back instruction to a shared storage section is provided; and

a tag control section configured not to invalidate a cache line for which the write-back instruction is already provided, and to invalidate a cache line for which the write-back instruction is not provided, when a predetermined instruction is provided from the instruction processing section.

(8) An information processing system including:

a shared storage section;

an instruction processing section;

a tag storage section configured to manage, for each cache line of a cache memory, whether or not the cache line is valid, and whether or not a write-back instruction to a shared storage section is provided; and

a tag control section configured not to invalidate a cache line for which the write-back instruction is already provided, and to invalidate a cache line for which the write-back instruction is not provided, when a predetermined instruction is provided from the instruction processing section.

(9) A cache control method including:

receiving an invalidate instruction intended to invalidate a cache line for which write-back instruction from a cache memory to a shared storage section is not provided; and

avoiding invalidating a cache line for which the write-back instruction is already provided, and invalidating a cache line for which the write-back instruction is not provided, when receiving the invalidate instruction.

It should be understood by those skilled in the art that various modifications, combinations, sub-combinations, and alterations may occur depending on design requirements and other factors insofar as they are within the scope of the appended claims or the equivalents thereof.

What is claimed is:

1. A cache control device comprising:
a tag storage section configured to manage, for each cache line of a cache memory, whether or not the cache line is valid, and whether or not a write-back instruction to a shared storage section is provided; and
a tag control section configured not to invalidate a cache line for which the write-back instruction is already provided, and to invalidate a cache line for which the write-back instruction is not provided, when a predetermined instruction is provided.

2. The cache control device according to claim 1, wherein the tag control section is configured to cause, when the write-back instruction is provided, the tag storage section to store content indicating that the write-back is instructed, and the tag control section is configured to cause, when the predetermined instruction is provided, the tag storage section to store content indicating that the write-back instruction is not provided, for the cache line for which the write-back instruction is already provided.

3. The cache control device according to claim 1, wherein the predetermined instruction is an instruction intended to invalidate the cache line for which the write-back instruction is not provided.

4. The cache control device according to claim 1, wherein the predetermined instruction is provided before processing of a thread is newly executed.

5. The cache control device according to claim 1, wherein the write-back instruction is provided after processing of a thread is performed.

6. The cache control device according to claim 1, wherein the tag storage section is configured to store, for each cache line,
a validity flag indicating whether the cache line is valid or invalid, and
a write-back flag indicating whether write-back of data corresponding to the cache line to the shared storage section is instructed or not.

7. A processor comprising:
an instruction processing section;
a tag storage section configured to manage, for each cache line of a cache memory, whether or not the cache line is valid, and whether or not a write-back instruction to a shared storage section is provided; and
a tag control section configured not to invalidate a cache line for which the write-back instruction is already provided, and to invalidate a cache line for which the write-back instruction is not provided, when a predetermined instruction is provided from the instruction processing section.

8. An information processing system comprising:
a shared storage section;
an instruction processing section;
a tag storage section configured to manage, for each cache line of a cache memory, whether or not the cache line is valid, and whether or not a write-back instruction to a shared storage section is provided; and
a tag control section configured not to invalidate a cache line for which the write-back instruction is already provided, and to invalidate a cache line for which the write-back instruction is not provided, when a predetermined instruction is provided from the instruction processing section.

9. A cache control method comprising:
receiving an invalidate instruction intended to invalidate a cache line for which write-back instruction from a cache memory to a shared storage section is not provided; and
avoiding invalidating a cache line for which the write-back instruction is already provided, and invalidating a cache line for which the write-back instruction is not provided, when receiving the invalidate instruction.
